(19) United States
(12) Patent Application Publication
(10) Pub. No.: US 2016/0203283 A1
(43) Pub. Date: Jul. 14, 2016

(54) SYSTEM AND METHOD FOR FACILITATING DIAGNOSTIC AND MAINTENANCE OF A MEDICAL DEVICE

(71) Applicant: HCL TECHNOLOGIES LTD., Noida (IN)

(72) Inventors: Shantanu BARUAH, Bedminster Township, NJ (US); Rohit SETHI, Bedminster Township, NJ (US)

(21) Appl. No.: 14/636,785

(22) Filed: Mar. 3, 2015

(30) Foreign Application Priority Data
Jan. 14, 2015 (IN) 116/DEL/2015

(51) Int. Cl. G06F 19/00

(52) U.S. Cl. CPC G06F 19/3412

(57) ABSTRACT

Disclosed is a system for facilitating diagnostic and maintenance of a medical device used for treatment of a patient. The system comprises a data capturing module for capturing data pertaining to a medical device. The data may be captured from one or more data sources comprising Picture Archiving and Communication System (PACS), Electronic Medical Record (EMR) systems, and Device Monitoring System. Further, the system comprises an analysis module for deriving meaningful information from the data by performing data analytics on the data. Further, the system comprises a prediction module for predicting insights associated to the medical device based on the meaningful information, wherein the insights facilitate in diagnosis and maintenance of the medical device.

### CROSS REFERENCE To RELATED APPLICATIONS

The present Application claims priority to Indian Patent Application No. 116/DEL/2015 filed on Jan. 14, 2015, the entirety of which is hereby incorporated by reference.

### TECHNICAL FIELD

The present subject matter described herein, in general, relates to, management of a medical device, and more particularly relates to system and method for facilitating diagnostic and maintenance of the medical device used for treatment of a patient.

### BACKGROUND

With the cost of healthcare increasing and Medical Device Companies (MDCs) becoming highly competitive, MDCs need innovative ways to be more cost efficient and provide value added services rather than only selling medical devices. In the eco system consisting of patients, surgeons and the MDCs, there are multiple challenges faced today while providing improved health outcomes to the patient.

The first challenge is that of collaboration and engagement. When the patient visits the surgeon to review his/her disease symptoms, the surgeon may initially conduct multiple diagnostic tests (such as blood/X-ray/Ultrasound/or MRI) from different hospitals and thereby creating the patient's medical record. Usually, the patient's medical record is stored as Electronic Medical Record (EMR) in a Picture Archiving and Communication System (PACS). Since the reports of the multiple diagnostic tests conducted are resided with each respective hospital, the patient or the hospital have no means to access/analyze the reports resided with other hospital. Further, after examining the patient's medical record, the surgeon schedules the surgery for the patient. In order to schedule the surgery, there are series of planning activities that service provider needs to collaborate with the MDCs (for replenishment) and complete many pre-requisites for Operation Room (OR) setup. Thus, it becomes very tedious task for the service provider and the MDC to collaborate for completing the pre-requisites for the OR setup before the surgery.

The second challenge is that of productivity and inefficiency. It has been observed that the MDC devote a lot of time in dealing with failures of the medical device. Due to lack of visibility to the medical device usage pattern and patient history, the MDCs have very limited ability to bring more innovative and value products/services in improving health outcomes of the patient. In addition, the MDCs further lacks in capability to perform remote diagnostics and proactively plan maintenance of the medical devices. This is because maintenance of the medical devices happens as schedule maintenance or in a reactive manner. For example, in case of malfunctioning of the medical device, a technician of the MDCs may first analyze the cause of the malfunctioning resulting in a second visit for replacing the parts of the medical devices.

### SUMMARY

Before the present systems and methods, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. This summary is provided to introduce concepts related to systems and methods facilitating diagnostic and maintenance of a medical device used for treatment of a patient and the concepts are further described below in the detailed description.

In one implementation, a system for facilitating diagnostic and maintenance of a medical device used for treatment of a patient is disclosed. In one aspect, the system may comprise a processor and a memory coupled to the processor. The processor may execute a plurality of modules present in the memory. The plurality of modules may comprise a data capturing module, an analysis module, and a prediction module. The data capturing module may capture data pertaining to a medical device. The data may be captured from one or more data sources. Examples of the one or more data sources may comprise Picture Archiving and Communication System (PACS), Electronic Medical Record (EMR) systems, and Device Monitoring System. The analysis module may derive meaningful information from the data by performing data analytics on the data. The prediction module may predict insights associated to the medical device based on the meaningful information. The insights may facilitate in diagnosis and maintenance of the medical device.

In another implementation, a method for facilitating diagnostic and maintenance of a medical device used for treatment of a patient is disclosed. In one aspect, in order to facilitate diagnostic and maintenance, initially, data pertaining to a medical device may be captured. The data may be captured from one or more data sources. The one or more data sources may comprise Picture Archiving and Communication System (PACS), Electronic Medical Record (EMR) systems, and Device Monitoring System. After capturing the data, meaningful information may be derived from the data by performing data analytics on the data. Subsequent to the derivation of the meaningful information, insights associated to the medical device may be predicted based on the meaningful information. The insights may facilitate in diagnosis and maintenance of the medical device. In one aspect, the aforementioned method for facilitating diagnostic and maintenance of the medical device used for treatment of the patient is performed by a processor using programmed instructions stored in a memory.

In yet another implementation, non-transitory computer readable medium embodying a program executable in a computing device facilitating diagnostic and maintenance of a medical device used for treatment of a patient is disclosed. The program may comprise a program code for capturing data pertaining to a medical device. The data may be captured from one or more data sources. The one or more data sources may comprise Picture Archiving and Communication System (PACS), Electronic Medical Record (EMR) systems, and Device Monitoring System. The program may comprise a program code for deriving meaningful information from the data by performing data analytics on the data. The program may comprise a program code for predicting insights associated to the medical device based on the meaningful information. The insights may facilitate in diagnosis and maintenance of the medical device.

### BRIEF DESCRIPTION OF THE DRAWINGS

The foregoing detailed description of embodiments is better understood when read in conjunction with the appended drawings. For the purpose of illustrating the disclosure, example constructions of the disclosure is shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for facilitating diagnostic and maintenance of a medical device used for treatment of a patient, in accordance with an embodiment of the present subject matter.

FIG. 2 illustrates the system, in accordance with an embodiment of the present subject matter.

FIGS. 3 and 4 illustrate examples, in accordance with an embodiment of the present subject matter.

FIG. 5 illustrates a method for facilitating diagnostic and maintenance of the medical device used for treatment of the patient, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

As there are various challenges observed in the existing art, these challenges necessitate the need for Medical Device Companies (MDCs) to build a collaborative healthcare platform. The collaborative healthcare platform aims to provide key insights enabling the MDCs to follow proactive approach while delivering services. In order to overcome the challenges, the MDCs need insights of a medical device's usage pattern, efficacy, side effects and failures so as to proactively facilitate diagnosis and maintenance of the medical device. The present system and method focuses on capturing data pertaining to both patient and the medical device in a HIPPA/PHI/PII compliant way on the collaborative healthcare platform. The data captured may facilitate diagnosis and maintenance of the medical device and further enables various stakeholders to take adaptive decisions resulting in patient health outcome.

In order to facilitate diagnosis and maintenance of the medical device, initially, the data pertaining to a medical device may be captured and stored in an operational database associated to the collaborative healthcare platform. In one aspect, collaborative healthcare platform may be deployed on a cloud computing environment. It may be understood that the collaborative healthcare platform may be communicatively coupled with one or more data sources. The collaborative healthcare platform further provides a dashboard for facilitating a plurality of users to access the data captured from the one or more data sources. The one or more data sources may include, but not limited to, Picture Archiving and Communication System (PACS), Electronic Medical Record (EMR) systems, and Device Monitoring System. The PACS and the EMR systems contain patient medical history in the form of Digital Imaging and Communications in Medicine (DICOM) images. Example of the the Device Monitoring System may include, but not limited to, Data cloud.

In other words, the PACS, the EMR or the Device Monitoring System may facilitate collecting data involved through various phases of patient treatment (such as diagnosis to treatment to recovery). The data collected may then be analyzed in order to deduce meaningful information. The meaningful information may then be used to predict the insights associated to the medical device for the stakeholders to take necessary measures. For example, the insights may facilitate the MDC to predict breakdowns, replenishment and maintenance diagnosis of the medical device. The insights may further facilitate surgeons to collaborate with the MDC for successful surgery of the patient. The insights may further facilitate the doctors/nurses to take proactive point of care actions for recovery of the patient.

Thus, the collaborative healthcare platform collects the data from the entire Healthcare ecosystem to provide good visibility of the medical device usage, consumption, failures thereby facilitating, MDC diagnostic and maintenance of the medical device during breakdowns or malfunctioning.

While aspects of described system and method for diagnostic and maintenance of the medical device used for treatment of the patient and may be implemented in any number of different computing systems, environments, and/or configurations, the embodiments are described in the context of the following exemplary system.

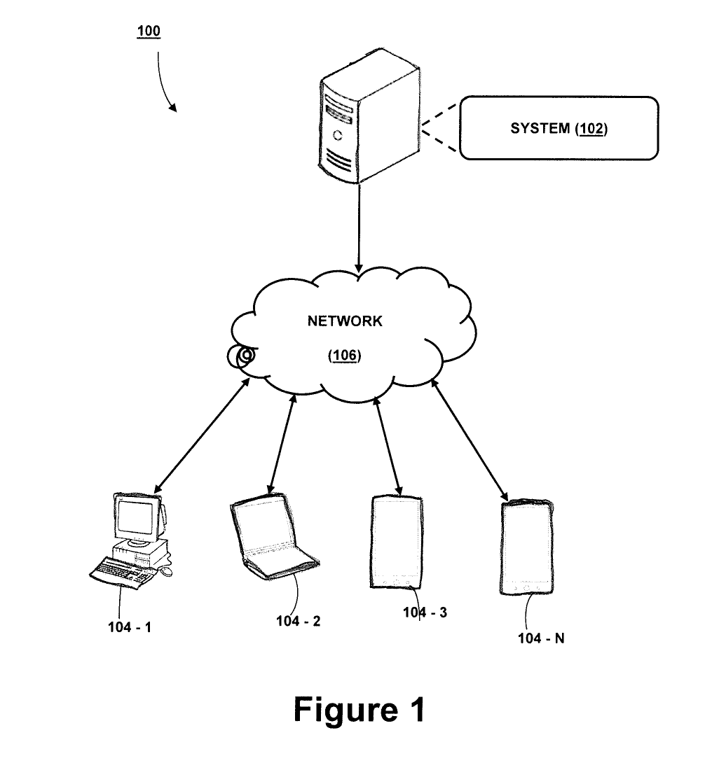

Referring now to FIG. 1, a network implementation 100 of a system 102 for facilitating diagnostic and maintenance of a medical device used for treatment of a patient is disclosed. In one aspect, in order to facilitate diagnostic and maintenance, initially, the system 102 captures data pertaining to a medical device. The data may be captured from one or more data sources. The one or more data sources may comprise Picture Archiving and Communication System (PACS), Electronic Medical Record (EMR) systems, and Device Monitoring System. After capturing the data, the system 102 derives meaningful information from the data by performing data analytics on the data. Subsequent to the derivation of the meaningful information, the system 102 predicts insights associated to the medical device may be predicted based on the meaningful information. The insights may facilitate in diagnosis and maintenance of the medical device.

Although the present disclosure is explained considering that the system 102 is implemented on a server, it may be understood that the system 102 may also be implemented in a variety of computing systems, such as a laptop computer, a desktop computer, a notebook, a workstation, a mainframe computer, a server, a network server, a cloud-based computing environment. It will be understood that the system 102 may be accessed by multiple users through one or more user devices 104-1, 104-2 . . . 104-N, collectively referred to as user 104 or stakeholders, hereinafter, or applications residing on the user devices 104. In one implementation, the system 102 may comprise the cloud-based computing environment in which a user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

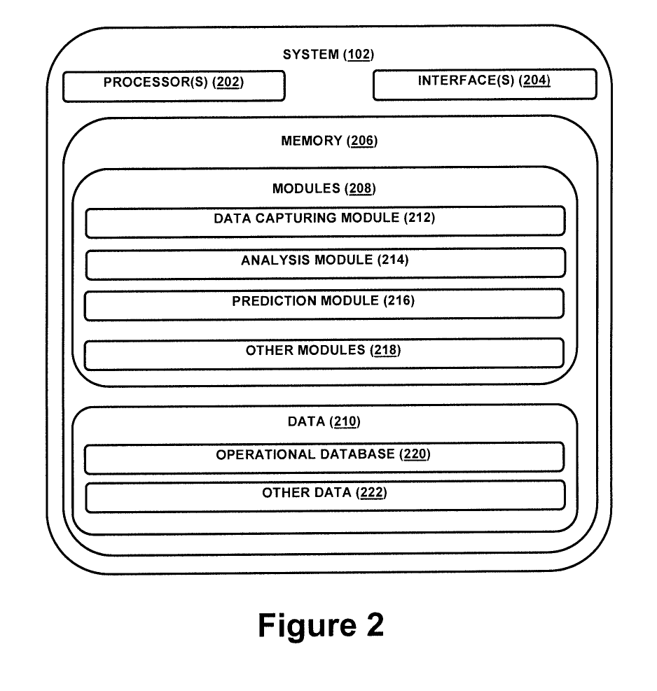

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a data capturing module 212, an analysis module 214, a prediction module 216, and other modules 218. The other modules 218 may include programs or coded instructions that supplement applications and functions of the system 102. The modules 208 described herein may be implemented as software modules that may be executed in the cloud-based computing environment of the system 102.

The data 210, amongst other things, serves as a repository for storing data processed, received, and generated by one or more of the modules 208. The data 210 may also include an operational database 220 and other data 222. The other data 222 may include data generated as a result of the execution of one or more modules in the other modules 218.

As there are various challenges observed in the existing art, the challenges necessitate the need for Medical Device Companies (MDCs) to build the system 102, hereinafter referred to as a collaborative healthcare platform. The collaborative healthcare platform aims to provide key insights enabling the MDCs to follow proactive approach for delivering services. In one embodiment, collaborative healthcare platform may be deployed on a cloud environment. In order overcome the challenges, the MDCs need insights of a medical device's usage pattern, efficacy, side effects and failures so as to proactively facilitate diagnosis and maintenance of the medical device. In order to facilitate diagnosis and maintenance, at first, a user may use the client device 104 to access the collaborative healthcare platform via the I/O interface 204. The user may register them using the I/O interface 204 in order to use the collaborative healthcare platform. In one aspect, the user may access the I/O interface 204 of the collaborative healthcare platform. The collaborative healthcare platform may employ the data capturing module 212, the analysis module 214, and the prediction module 216 for facilitating diagnostic and maintenance of the medical device used for treatment of the patient.

Further referring to FIG. 2, the data capturing module 212 captures data pertaining to the medical device from one or more data sources. It may be understood that the collaborative healthcare platform may be communicatively coupled with the one or more data sources. Examples of the one or more data sources may include, but not limited to, Picture Archiving and Communication System (PACS), Electronic Medical Record (EMR) systems, and Device Monitoring System. Examples of the data may include, but not limited to, hospital location, medical device details, patient medical records, medical device sales, medical device health information, medical device usage pattern, and blood/X-ray/Ultrasound/or MRI reports. In one aspect, the data captured, from the one or more data sources, is stored in an operational database 220 associated to the collaborative healthcare platform.

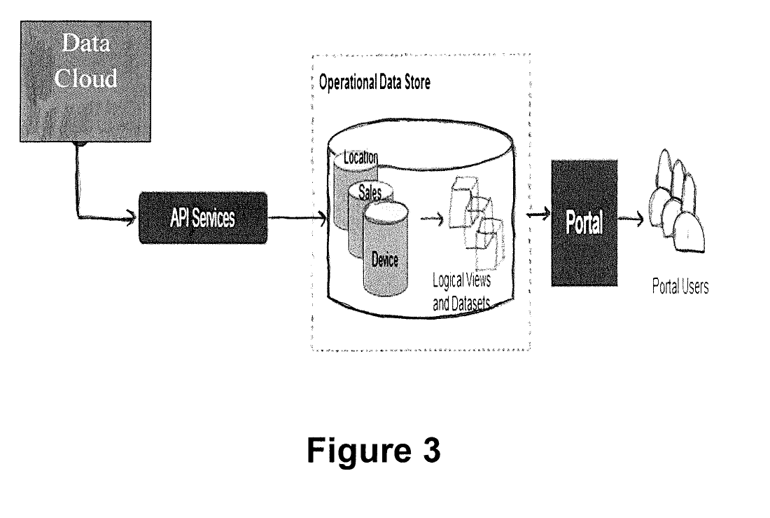

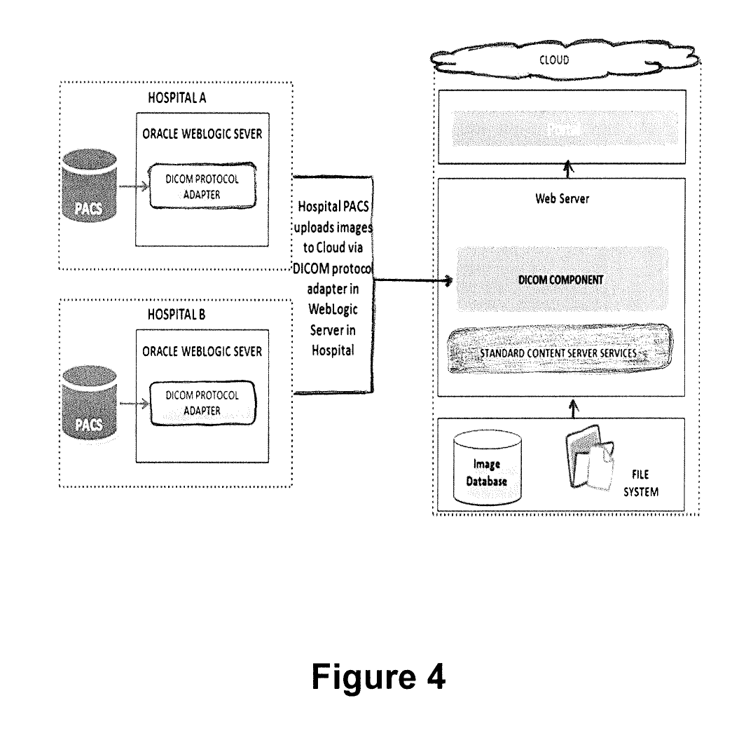

In order to capture the data from the Device Monitoring System, the data capturing module 212 for capturing the data from the Device Monitoring System such as Data cloud illustrated in FIG. 3. As shown, in the FIG. 4, the data pertaining to the medical device is stored on the Data cloud. In order to retrieve the data, the data capturing module 212 utilizes Application Programming Interfaces (APIs) to retrieve the data (such as medical device usage and performance information) from the Data cloud. Example of the API may include, but not limited to by using a Representational state transfer (RESTful) API. Since the data retrieved is in unstructured format, the data capturing module 212 further structures the data by storing the data in one or more tables of the operational database 220. The tables, within the operational database 220, are populated with hospital location, product details, and medical device sales. Further the tables are joined to create logical views of the tables. In one aspect, the logical views are indicative of summarized information pertaining to the medical device used for facilitating diagnostic and maintenance of the medical device. The data capturing module 212 further displays the summarized information on a dashboard of the collaborative healthcare platform in order to facilitate a plurality of users to access the data.

Further, in order to capture the data from PACS and the EMR systems, the PACS and the EMR systems are connected with Digital Imaging and Communications in Medicine (DICOM) adaptors installed within the hospital network as shown in FIG. 4. After connecting the DICOM adaptors, appropriate DICOM configurations are made in the DICOM adaptors. After configuring the DICOM adaptors, the surgeon/hospital staff selects the data, to be transmit, stored in the PACS. Upon selection, the data is transmitted to the operational database 220 associated with the collaborative healthcare platform. In one aspect, the data may be transmitted by the DICOM adaptors to DICOM adapter component associated to the collaborative healthcare platform (also referred as portal in the FIG. 4). The data capturing module 212 may then display the data (blood/X-ray/Ultrasound/or MRI reports) on the dashboard of the collaborative healthcare platform.

In one embodiment, the data capturing module 212 captures the data based on appropriate privacy policy defined for accessing the confidential data pertaining to different stakeholders such as patients or surgeons. Once the stakeholder provides their consent for sharing the data, the data capturing module 212 captures the data based on methodology as aforementioned.

After capturing the data, the analysis module 214 analyzes the data in order to derive meaningful information. In one aspect, the analysis module 214 analyzes the data by performing data analytics on the data. In one embodiment, the analysis may be performed by the analysis module 214 based on one or more pre-determined rules. The data captured through the system 102 is raw or in the unstructured format that provide essential performance statistics of the medical devices used for the treatment. In one example, a cement mixer used for mixing cement under vacuum for bone graft and treatment needs to perform mixing a particular speed and the whole exercise is time bound—usually requires 3-6 minutes. Another important element of the mixing is protecting the medical staff from harmful fume exposures. It may be understood that the data such as machine data such as rpm (rotation per minute) of the machine, completion time of a routine, and lid positions is captured and stored on a data cloud. Upon capturing the data, the analysis module 214 may implement the one or more pre-determined rules on the data in order to derive the meaningful information. For example, in the cement mixer case if the rpm is less than 2000 rpm or if the time taken to complete one procedure is exceeding 8 minutes are clear signs of machine early warnings of falter. In such a scenario, the analysis module 214 has preset rules to catch this trend and report back accordingly.

Subsequent to the derivation of the meaningful information, the prediction module 216 predicts insights for the stakeholders to take necessary measures. For example, the insights may facilitate the MDCs to predict breakdowns, replenishment and maintenance diagnosis of the medical device. The insights may further facilitate surgeons to collaborate with the MDCs for successful surgery of the patient. The insights may further facilitate the doctors/nurses to take proactive point of care actions for recovery of the patient. The collaborative healthcare platform captures the data from the entire Healthcare ecosystem to provide good visibility of the medical device usage, consumption, failures thereby facilitating, diagnostic and maintenance of the during breakdowns or malfunctioning of the medical device. Thus, in this manner, the collaborative healthcare platform facilitates diagnostic and maintenance of the medical device used for treatment of the patient.

In order to understand the prediction of the insights associated to a medical device, consider an example where the medical is “Bone cutting driver/saw” used in an operation room. In order to facilitate the diagnostic and maintenance of the “Bone cutting driver/saw”, data pertaining to the “Bone cutting driver/saw” is captured from the Device Monitoring System. The data captured from the Device Monitoring System is ‘Battery charge start time and end time’, ‘Operating start time and end time’, ‘Drill speed while in use and change in drill speeds’, ‘Service call history’, ‘Model number’, ‘location’, ‘serial number’, ‘recording date and time for every data entry’.

Once the data is captured, the meaningful information is derived from the data. In one aspect, the meaningful information derived to determine: Average life of the battery, Level of the battery charge level of the device when the surgery started and ended, Time taken to charge the battery, Number of times the battery was charged (in given period), Average time for charging the battery, Number of times insertions done in the sterilization unit, and Number of times device complaints were received.

After deriving the meaningful information, the insights are predicted to facilitate diagnostic and maintenance of the “Bone cutting driver/saw”. In one aspect, the insights may include, but not limited to, Time to order a new battery for the “Bone cutting driver/saw”, Expected time to recharge the battery, Suggested date and time to schedule maintenance of the “Bone cutting driver/saw”.

Similarly, when the medical device is “LED light” used in operation rooms, data pertaining to the “LED light” is captured from the Device Monitoring System. The data captured from the Device Monitoring System is ‘Time when put to ready mode, standby mode, off mode’, ‘Operating start time and end time when in Ready mode, ‘Safety cable disconnect and connect event entries’, ‘Service call history’, ‘Model number’, ‘location’, ‘Serial number’, ‘Recording date’, and ‘Time for every data entry’.

Once the data pertaining to the “LED light” is captured, the meaningful information is derived from the data. In one aspect, the meaningful information derived from the data is to determine: Ratio of Time the device is in running mode and standby mode, Number of times the safety cable got detached per month, Proportion of range of lights levels when the device is on, Number of times power turned off and on, and Monthly history of service calls over a period of time.

After deriving the meaningful information, the insights are predicted thereby facilitating diagnostic and maintenance of the medical device (“LED light”). In one aspect, the insights may include, but not limited to, Probable Time the LED will deteriorate, Probable Time to order replenishment for the LED, Probable date and time to schedule maintenance of the LED light.

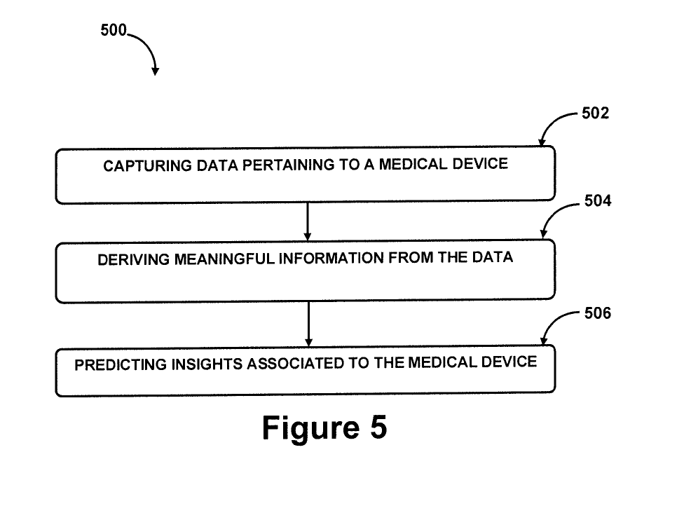

Referring now to FIG. 5, a method 500 for facilitating diagnostic and maintenance of a medical device used for treatment of a patient is shown, in accordance with an embodiment of the present subject matter. The method 500 may be described in the general context of computer executable instructions. Generally, computer executable instructions can include routines, programs, objects, components, data structures, procedures, modules, functions, etc., that perform particular functions or implement particular abstract data types. The method 500 may also be practiced in a distributed computing environment where functions are performed by remote processing devices that are linked through a communications network. In a distributed computing environment, computer executable instructions may be located in both local and remote computer storage media, including memory storage devices.

The order in which the method 500 is described is not intended to be construed as a limitation, and any number of the described method blocks can be combined in any order to implement the method 500 or alternate methods. Additionally, individual blocks may be deleted from the method 500 without departing from the spirit and scope of the subject matter described herein. Furthermore, the method can be implemented in any suitable hardware, software, firmware, or combination thereof. However, for ease of explanation, in the embodiments described below, the method 500 may be considered to be implemented as described in the system 102.

At block 502, data pertaining to a medical device may be captured. In one aspect, the data may be captured from one or more data sources. The one or more data sources may comprise Picture Archiving and Communication System (PACS), Electronic Medical Record (EMR) systems, and Device Monitoring System. In one implementation, the plurality of UI elements may be extracted by the data capturing module 212.

At block 504, meaningful information may be derived from the data by performing data analytics on the data. In one implementation, the meaningful information may be derived by the analysis module 214.

At block 506, insights associated to the medical device may be predicted based on the meaningful information. In one aspect, the insights facilitate in diagnosis and maintenance of the medical device. In one implementation, the insights may be predicted by the prediction module 216.

Exemplary embodiments discussed above may provide certain advantages. Though not required to practice aspects of the disclosure, these advantages may include those provided by the following features.

Some embodiments enable a system and a method to provide greater visibility throughout patient journey.

Some embodiments enable a system and a method to adopt a proactive approach for managing hospital equipment.

Some embodiments enable a system and a method to provide visibility of medical device performance and further help in facilitating remote diagnostics to the medical device.

Some embodiments enable a system and a method to enable better forecasting based on current and projected usage of the medical device.

Although implementations for methods and systems for facilitating diagnostic and maintenance of a medical device used for treatment of a patient have been described in language specific to structural features and/or methods, it is to be understood that the appended claims are not necessarily limited to the specific features or methods described. Rather, the specific features and methods are disclosed as examples of implementations for facilitating diagnostic and maintenance.

We claim:

1. A method for facilitating diagnostic and maintenance of a medical device used for treatment of a patient, the method comprising:
capturing, by a processor, data pertaining to a medical device, wherein the data is captured from one or more data sources, and wherein the one or more data sources comprises Picture Archiving and Communication System (PACS), Electronic Medical Record (EMR) systems, and Device Monitoring System;
deriving, by the processor, meaningful information from the data by performing data analytics on the data; and
predicting, by the processor, insights associated to the medical device based on the meaningful information, wherein the insights facilitate in diagnosis and maintenance of the medical device.

2. The method of claim 1, wherein the data comprises hospital location, medical device details, patient medical records, medical device sales, medical device health information, and medical device usage pattern.

3. The method of claim 1, wherein the data is captured, from the Device Monitoring System, by using a Representational state transfer (RESTful) Application Programming Interface (API), and wherein the data is stored in an operational database.

4. The method of claim 1, wherein the data is captured, from the PACS, by using a Digital Imaging and Communications in Medicine (DICOM) adaptor.

5. A system for facilitating diagnostic and maintenance of a medical device used for treatment of a patient, the system comprising:
a processor; and
a memory coupled to the processor, wherein the processor is capable of executing a plurality of modules stored in the memory, and wherein the plurality of module comprising:
a data capturing module for capturing data pertaining to a medical device, wherein the data is captured from one or more data sources, and wherein the one or more data sources comprises Picture Archiving and Communication System (PACS), Electronic Medical Record (EMR) systems, and Device Monitoring System;
an analysis module for deriving meaningful information from the data by performing data analytics on the data; and
a prediction module for predicting insights associated to the medical device based on the meaningful information, wherein the insights facilitate in diagnosis and maintenance of the medical device.

6. The system of claim 5, wherein the data is captured, from the Device Monitoring System, by using a Representational state transfer (RESTful) Application Programming Interface (API), and wherein the data is stored in an operational database.

7. The system of claim 5, wherein the data is captured, from the PACS, by using a Digital Imaging and Communications in Medicine (DICOM) adaptor.

8. A non-transitory computer readable medium embodying a program executable in a computing device for facilitating diagnostic and maintenance of a medical device used for treatment of a patient, the program comprising a program code comprising:
a program code for capturing data pertaining to a medical device, wherein the data is captured from one or more data sources, and wherein the one or more data sources comprises Picture Archiving and Communication System (PACS), Electronic Medical Record (EMR) systems, and Device Monitoring System;
a program code for deriving meaningful information from the data by performing data analytics on the data; and
a program code for predicting insights associated to the medical device based on the meaningful information, wherein the insights facilitate in diagnosis and maintenance of the medical device.
